(19) United States
(12) Patent Application Publication
(10) Pub. No.: US 2015/0294827 A1
(43) Pub. Date: Oct. 15, 2015

(54) FUSE LINK SYSTEMS AND METHODS

(71) Applicant: S&C Electric Company, Chicago, IL (US)

(72) Inventors: Christopher LETTOW, Round Lake, IL (US); Jorge MONTANTE, Cicero, IL (US); Hector ROMAN, Chicago, IL (US); Richard G. SMITH, North Aurora, IL (US)

(21) Appl. No.: 14/682,247

(22) Filed: Apr. 9, 2015

Related U.S. Application Data
(60) Provisional application No. 61/978,528, filed on Apr. 11, 2014.

(51) Int. Cl. H01H 85/26; H01H 69/02

(52) U.S. Cl. CPC H01H 85/26; H01H 69/02

(57) ABSTRACT

A fuse link includes a conductive terminal component having a cylindrical insertion region with a knurled region formed therein and a fusible element electrically coupled thereto. A tubular sheath is configured to form a press-fit connection with the knurled region such that the tubular sheath substantially encloses the fusible element. The inner radius, the wall thickness, and the length of the tubular sheath are together configured to remain substantially intact when the fusible link experiences a first overload event within a first range of fault current values and burst when the fusible link experiences an overload event within a second range of fault current values that is greater than the first range.

### CROSS-REFERENCE TO RELATED APPLICATIONS

This application claims the benefit of U.S. Provisional Application No. 61/978,528 filed on Apr. 11, 2014, the entire disclosure of which is incorporated herein by reference.

### TECHNICAL FIELD

The technical field generally relates to interrupting equipment in power distribution systems, and more particularly relates to fuse cutouts used in connection with such systems.

### BACKGROUND

Power distribution systems include a variety of subsystems designed to protect transformers and other components from overload conditions and current surges. One such system is the fuse cutout—a protection device that is part fuse, part switch, and which is often used in connection with overhead feeder lines.

Fuse cutouts typically include a fuse tube rotatably coupled, at its lower end, to the cutout body. A fuse link assembly, which includes the actual fusible element, is installed within the fuse tube and is mechanically and electrically coupled (via an interference fit) to the top of the fuse cutout body. During an overload event, the fusible element in the fuse link melts and then mechanically separates and the fuse tube disconnects the electrical circuit by dropping the top end of the fuse tube out of the cutout body in a rotational manner.

An acceptable design for fuse links must account for several factors. For example, the fault-interrupting capability is dependent on the fuse link sheath. The interrupting performance of the fuse links must extend across the full range of possible faults conditions—i.e., from potentially tens of amperes at the low end to about 10,000 amperes at the high end. The fuse link should stay intact for a first range of fault current values, e.g. from tens of amperes to about 1,100 amperes to interrupt faults within the fuse link sheath, but also burst at a sufficiently low pressure to minimize the arc energy during transformer primary faults, a second range of fault current values from about 1,100 to about 10,000 amperes. A particular sheath material which provides desirable interrupting performance may require specific design features to yield optimal performance.

Accordingly, there is a need for improved fuse links of the type used in conjunction with fuse cutout systems. Other desirable features and characteristics of the present invention will become apparent from the subsequent detailed description and the appended claims, taken in conjunction with the accompanying drawings and the foregoing technical field and background.

### DESCRIPTION OF THE DRAWINGS

The exemplary embodiments will hereinafter be described in conjunction with the following drawing figures, wherein like numerals denote like elements, and wherein:

FIG. 1 is an isometric overview of fuse cut-out useful in describing various embodiments;

FIG. 2 is an isometric partial cut-away view of an exemplary fuse link in accordance with one embodiment;

FIG. 3 is an isometric overview of a fuse link terminal in accordance with one embodiment;

FIG. 4 is a side view of the fuse link terminal depicted in FIG. 3;

FIG. 5 is a cross-sectional view of a fuse link sheath in accordance with one embodiment; and

FIG. 6 is a cross-sectional view of an assembled fuse link in accordance with one embodiment.

### DETAILED DESCRIPTION

A fuse link in accordance with one embodiment includes a conductive terminal component having a generally cylindrical insertion region, the generally cylindrical insertion region having a knurled region formed therein; a fusible element electrically coupled to the conductive terminal component; and a generally tubular sheath having a first end, a length, an inner radius, and a wall thickness. The first end of the generally tubular sheath is configured to form a press-fit connection with the knurled region of the conductive terminal component such that the generally tubular sheath substantially encloses the fusible element. The inner radius, the wall thickness, and the length of the generally tubular sheath are together configured such that (a) the generally tubular sheath remains substantially intact when the fusible link experiences a first overload event within a first range of fault current values; and (b) does not remain substantially intact when the fusible link experiences an overload event within a second range of fault current values that is greater than the first range. For example, the interrupting performance of the fuse link extends across the full range of possible faults conditions—i.e., from tens of amperes at the low end to about 10,000 amperes at the high end. In particular, the fuse link should stay intact for the first range of fault current values, e.g. from tens of amperes to about 1,100 amperes to interrupt faults within the fuse link sheath, but also burst at a sufficiently low pressure to minimize the arc energy during transformer the second range of fault current values, e.g. from about 1,100 to about 10,000 amperes.

A fuse link in accordance with one embodiment includes a conductive terminal component and a generally tubular polymeric sheath. The conductive terminal component has a generally cylindrical insertion region, the generally cylindrical insertion region having a knurled region formed therein such that the knurled region includes a fraction of the cylindrical insertion region. In one embodiment, the knurled region is formed on at least 50% of the cylindrical insertion regions, and more preferably about 60-75% of the cylindrical insert region. The generally tubular polymeric sheath has a first end, a length, an inner radius, and a wall thickness, wherein the first end of the generally tabular polymeric sheath is configured to form a press-fit connection with the knurled region of the conductive terminal component. The inner radius, the wall thickness, and the length of the generally tubular polymeric sheath are together configured such that (a) the generally tubular sheath remains substantially intact when the fusible link experiences a first overload event within a first range of fault current values; and (b) does not remain substantially intact when the fusible link experiences an overload event within a second range of fault current values that is greater than the first range. The polymeric sheath may be formed using an acetal homopolymer resin such as acetal polyoxymethylene or POM, commercially available as DuPont™ Delrin® 150 extrusion grade material.

A method of forming a fuse link in accordance with one embodiment includes providing conductive terminal component having a generally cylindrical insertion region, the generally cylindrical insertion region having a knurled region formed therein. The method further includes providing a generally tubular sheath having a first end, a length, an inner radius, and a wall thickness that are together configured such that the generally tubular sheath remains substantially intact when the fusible link experiences a first overload event within a first range of fault current values; and does not remain substantially intact when the fusible link experiences an overload event within a second range of fault current values that is greater than the first range. The method further includes inserting the first end of the generally tubular sheath over the generally cylindrical insertion region to form a press-fit connection with the knurled region of the conductive terminal component.

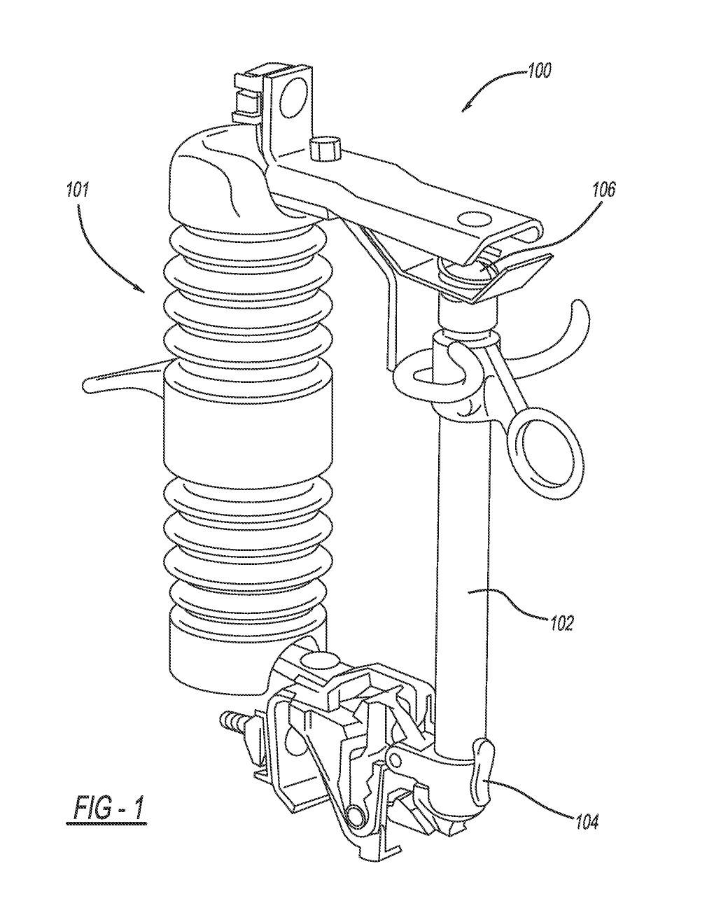

FIG. 1 is an isometric overview of an exemplary fuse cutout 100 useful in describing operation of fuse links in accordance with various embodiments. As illustrated, fuse cutout 100 includes a generally “C”-shaped body 101 (including various insulator and conductive components) and a substantially hollow fuse tube 102 rotatably coupled to cutout body 101 at one end 104. A fuse link assembly (not shown in FIG. 1) is installed within fuse tube 102 and is mechanically and electrically coupled (e.g., via an interference fit) to end 106 of fuse cutout body 101. A conductive cable or wire 208 extending from the fuse link is electrically coupled to end 104. In overhead applications, cutout 100 is generally mounted at a slightly forward-tipping angle (e.g., about 20-degrees) such that end 104 is positioned below end 106. During an overload event, the fuse link separates and end 106 of fuse tube 102 is released (rotationally with respect to end 104) out of cutout body 101, thereby creating an open circuit and providing a visual cue (via hanging fuse tube 102) that fuse cutout 100 has experienced a fault condition. The nature and operation of conventional fuse cutouts are known in the art, and need not be further described herein.

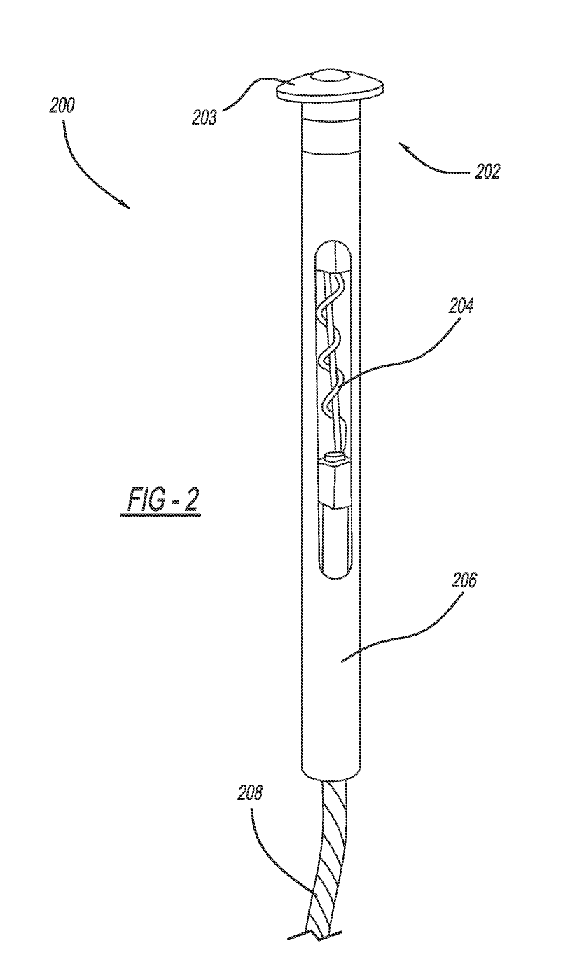

FIG. 2 is an isometric partial cut-away view of an exemplary fuse link 200 of the type that might be installed within fuse tube 102 of FIG. 1. In general, fuse link 200 includes a conductive terminal end (or simply “terminal”) 202 electrically coupled to an internal fusible element 204, which itself is electrically coupled to a conductive cable 208. A button 203 may be secured (e.g., via corresponding threaded surfaces) to terminal 202 as shown. Button 203 is configured to make electrical contact with a suitable structure (e.g., a spring loaded contact) at end 106 of fuse cutout 100. Fusible element 204 as well as a portion of terminal 202 (to which it is secured) are protected by a sheath 206, which generally consists of a tubular insulating structure designed to provide controlled failure of fuse link 200 during an overload event, as described in further detail below.

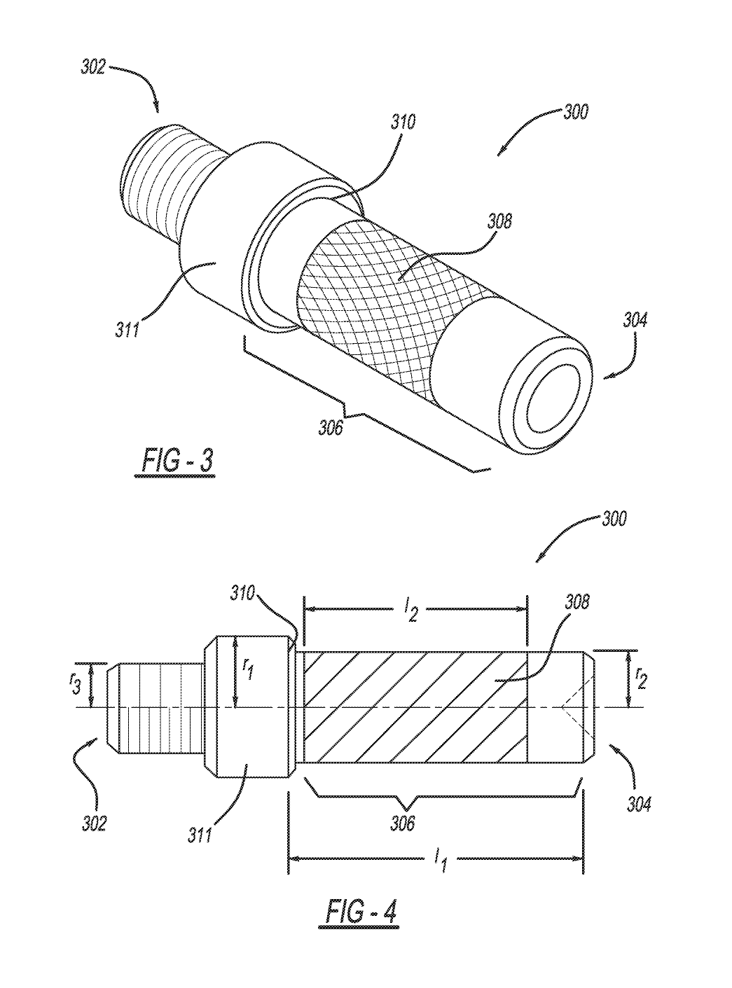

FIG. 3 is an isometric overview of a fuse link terminal (or simply terminal) 300 in accordance with one embodiment, and FIG. 4 is a corresponding side view of the fuse link terminal 300. As illustrated, terminal 300 is a single conductive component (e.g., aluminum, steel or other conductive metal) extending from end 302 (whose outer and/or inner diameter may be threaded to mechanically couple to a button 203 or other such component) to end 304, which is configured to mechanically couple to a fusible element (not illustrated). As shown in FIG. 4, end 304 of terminal 300 may include a conical bore to facilitate connection to the fusible element.

Terminal 300 includes a cylindrical surface region (or “insertion region”) 306 extending from a shoulder 310, which is formed by virtue of a region 311 having a greater outer diameter than region 306. In accordance with various embodiments, a portion of region 306—i.e., region 308—is knurled or otherwise textured to facilitate a press-fit connection with a sheath, as will be described in further detail below. Region 308 may be referred to without loss of generality herein as a “knurled region.” In this regard, a variety of knurling patterns may be used in connection with knurled region 308. Such patterns include, without limitation, “left hand”, “diamond”, “axial”, and “circumferential” knurling patterns. In one embodiment, knurled region 308 is approximately a left hand 40 teeth-per-inch (TPI) knurl.

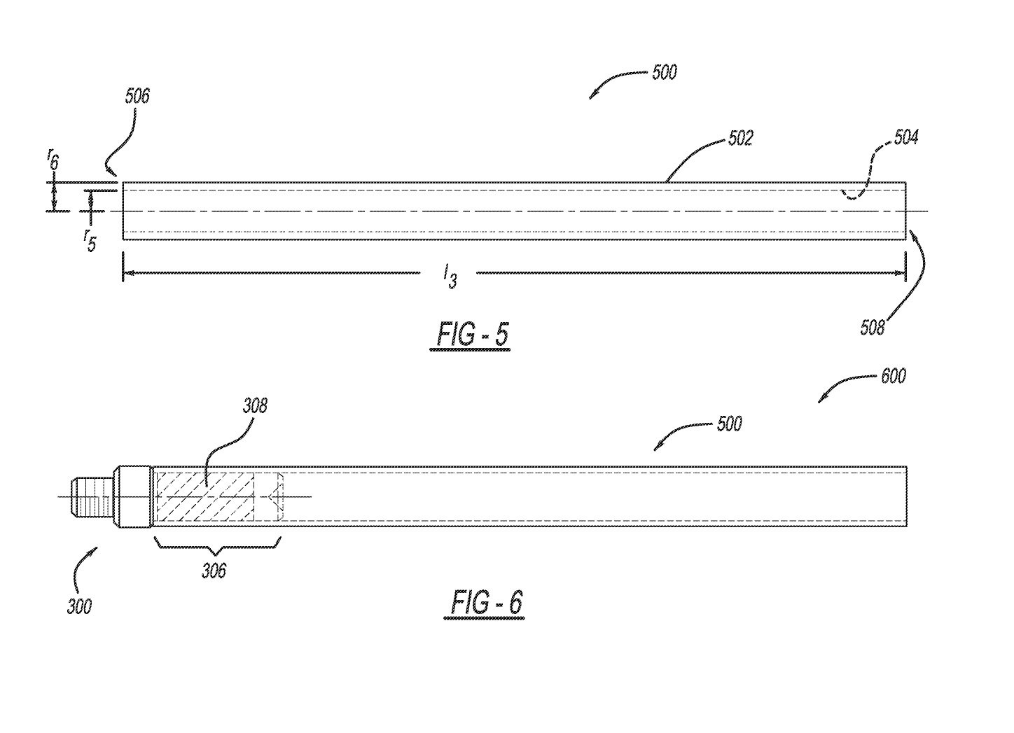

FIG. 5 is a cross-sectional view of an exemplary fuse link sheath (or simply “sheath”) 500 configured to mechanically couple with terminal 300 of FIG. 3. More particularly, sheath 500 is a generally tube-like structure having an outer surface 502 and an inner surface 504 extending from a first end 506 to an opposing second end 508. Inner surface 504 and outer surface 502 therefore define the sheath's wall thickness. The range of dimensions and materials used for implementing sheath 500 in accordance with various embodiments will be described in detail below, but in general sheath 500 is sufficiently deformable (elastically) that end 506 can accept and form a press-fit connection with region 306 of terminal 300, which may be beveled as shown to facilitate insertion. The required insertion force will generally vary depending upon geometrical factors, but in one embodiment is equal to approximately 800 lbf.

The resulting structure 600 (i.e., the assembled fuse link, sans fusible element) is illustrated in FIG. 6. Due to the added gripping capability of knurled region 308, the mechanical connection between terminal 300 and sheath 500 is greatly strengthened as compared to conventional tolerance fit and adhesive connections. In one embodiment, the resulting connection can withstand a torque of greater than approximately 10 in-lbf.

Having thus given an overview of a fuse link assembly in accordance with various embodiments, example physical dimensions will now be described in conjunction with FIGS. 4 and 5. In general, the example embodiments have been found to exhibit superior performance across their respective current ratings and balance a variety of factors. For example, it is desirable that the wall thickness of sheath 500 be large enough that it remains substantially intact and contains the resulting arc energy during a relatively low-current event within a first range of values (e.g., greater than the nominal current rating of the fuse link and less than about 1,100 amperes). At the same time, it is desirable that the wall thickness of sheath 500 not be too thick such that it does not burst at a target pressure produced by relatively high fault-current events falling within a second range of values (e.g., approximately 8,000-11,000 amperes). Similarly, the length of sheath 500 is preferably long enough to extinguish an arc occurring at a relatively low fault-current before the fusible element is pulled out of the sheath, and not so long that it results in a large pressure differential (between the interior of the sheath and the exterior of the sheath) during a relatively high current event.

In accordance with a first example, dimensions for a fuse link rated in the range of 1-50 amperes (continuous) will now be described. Referring to FIG. 4, a terminal 300 for use in such an embodiment has a shoulder portion 310 having a radius, r₁, of approximately 0.140 inch (abbreviated 0.140″) (3.56 mm), a cylindrical contact region 306 having a length, l₁, of approximately 0.963″ (24.5 mm), and a radius, r₂, of approximately 0.108″ (2.74 mm). Knurled region 308 has a length, l₂, of approximately 0.603″ (15.3 mm). Thus, approximately 63% of region 306 is knurled. Knurled region 308 may be coterminous with shoulder 310, or may be offset from shoulder 310 by a predetermined distance (e.g., about 0.60″, as illustrated). Threaded end 302 of terminal 300 in this embodiment has a radius, r₃, of approximately 0.123″ (3.12 mm).

Continuing with the first example, and referring to FIG. 5, an exemplary sheath 500 in accordance with this embodiment has a total length, l₃, of approximately 5.65″ (14.4 cm), an inner radius, r₅, of approximately 0.105″ (2.67 mm), and an outer radius, r₆, of approximately 0.177″ (4.50 mm). Thus, the wall thickness of sheath 500 (between inner surface 504 and outer surface 502) is approximately 0.069″ (1.75 mm). Normalizing these dimensions such that the inner radius r₅ has a normalized dimension of 1.0, the wall thickness of the generally tubular sheath has a normalized dimension of approximately 0.65, and the length of generally tubular sheath has a normalized dimension of approximately 54.0. While a variety of insulative or dielectric materials may be used for sheath 500, a presently preferred material includes acetal homopolymer resin.

In accordance with a second example, dimensions for a fuse link rated between 60 amperes and 100 amperes (continuous) will now be described. Referring to FIG. 4, a terminal 300 for use in such an embodiment has a shoulder portion 310 having a radius, r₁, of approximately 0.203″ (5.16 min), a cylindrical contact region 306 having a length, l₁, of approximately 0.875″ (22.2 mm) and a radius, r₂, of approximately 0.155″ (3.94 mm). Knurled region 308 has a length, l₂, of approximately 0.635″ (16.1 mm). Thus, approximately 73% of region 306 is knurled. Knurled region 308 may be coterminous with shoulder 310, or may be offset from shoulder 310 by a predetermined distance (e.g., about 0.04″ (1.02 mm), as illustrated). Threaded end 302 of terminal 300 in this embodiment has a radius, r₃, of approximately 0.145″ (3.68 mm).

Continuing with the second example, and referring to FIG. 5, an exemplary sheath 500 in accordance with this embodiment has a total length, l₃, of approximately 5.65″ (14.4 cm), an inner radius, r₅, of approximately 0.154″ (3.9 mm), and an outer radius, r₆, of approximately 0.205″ (5.2 mm). Thus, the wall thickness of sheath 500 (between inner surface 504 and outer surface 502) has a thickness of approximately 0.044″ (1.12 mm). Again normalizing these dimensions such that the inner radius r₅ has a normalized dimension of 1.0, the wall thickness of the generally tabular sheath has a normalized dimension of approximately 0.28, and the length of generally tubular sheath has a normalized dimension of approximately 37.0. As with the embodiment above, a variety of insulative materials may be used for sheath 500 including ing acetal homopolymer resin.

While at least one exemplary embodiment has been presented in the foregoing detailed description, it should be appreciated that a vast number of variations exist. It should also be appreciated that the exemplary embodiment or exemplary embodiments are only examples, and are not intended to be models or otherwise limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fuse link comprising:
a conductive terminal component having a generally cylindrical insertion region, the generally cylindrical insertion region having a knurled region formed therein;
a fusible element electrically coupled to the conductive terminal component; and
a generally tubular sheath having a first end, a length, an inner radius, and a wall thickness;
wherein the first end of the generally tubular sheath is configured to form a press-fit connection with the knurled region of the conductive terminal component such that the generally tubular sheath substantially encloses the fusible element;
wherein the inner radius, the wall thickness, and the length of the generally tubular sheath are together configured such that (a) the generally tubular sheath remains substantially intact when the fusible link experiences a first overload event within a first range of fault current values; and (h) does not remain substantially intact when the fusible link experiences an overload event within a second range of fault current values that is greater than the first range.

2. The fuse link of claim 1, wherein the first range of fault current values ranges from tens of amperes to approximately 1,100 amperes, and the second range of fault current values ranges from about 1,100 amperes to about 10,000 amperes.

3. The fuse link of claim 1, wherein the generally tubular sheath comprises an acetal homopolymer material.

4. The fuse link of claim 1, wherein the knurled region comprises a fraction of the cylindrical insertion region.

5. The fuse link of claim 1, wherein the fusible element has a current rating of about 1-50 amperes, and wherein the inner radius of the generally tubular sheath has a normalized dimension of 1.0, the wall thickness of the generally tubular sheath has a normalized dimension of approximately 0.65, and the length of generally tubular sheath has a normalized dimension of approximately 54.0.

6. The fuse link of claim 5, wherein the inner radius of the generally tubular sheath is approximately 0.105 inch.

7. The fuse link of claim 11, wherein the fusible element has a current rating in the range of 60-100 amperes, further wherein the inner radius of the generally tubular sheath has a normalized dimension of 1.0, the wall thickness of the generally tubular sheath has a normalized dimension of approximately 0.28, and the length of generally tubular sheath has a normalized dimension of approximately 37.0.

8. The fuse link of claim 7, wherein the inner radius of the generally tubular sheath is approximately 0.154 inch.

9. A fuse link comprising:
a conductive terminal component having a generally cylindrical insertion region, the generally cylindrical insertion region having a knurled region formed therein such that the knurled region is formed on a fraction of the cylindrical insertion region;
a generally tubular polymeric sheath having a first end, a length, an inner radius, and a wall thickness, wherein the first end of the generally tubular polymeric sheath is configured to form a press-fit connection with the knurled region of the conductive terminal component;
wherein the inner radius, the wall thickness, and the length of the generally tubular polymeric sheath are together configured such that (a) the generally tubular sheath remains substantially intact when the fusible link experiences a first overload event within a first range of fault current values; and (b) does not remain substantially intact when the fusible link experiences an overload event within a second range of fault current values that is greater than the first range.

10. The fuse link of claim 9, wherein the first range of fault current values ranges from tens of amperes to approximately 1,100 amperes, and the second range of fault current values ranges from about 1,100 amperes to about 10,000 amperes.

11. The fuse link of claim 9, wherein the generally tubular polymeric sheath comprises an acetal homopolymer material.

12. The fuse link of claim 9, wherein the knurled region is formed on at least 50% of the cylindrical insertion region.

13. The fuse link of claim 9, wherein the fusible element has a current rating of about 50 amperes, and wherein the inner radius of the generally tubular polymeric sheath has a normalized dimension of 1.0, the wall thickness of the generally tubular polymeric sheath has a normalized dimension of approximately 0.65, and the length of generally tubular polymeric sheath has a normalized dimension of approximately 54.0.

14. The fuse link of claim 13, wherein the inner radius of the generally tubular polymeric sheath is approximately 0.105 inch.

15. The fuse link of claim 14, wherein the fusible element has a current rating of about 60-100 amperes, further wherein the inner radius of the generally tubular polymeric sheath has a normalized dimension of 1.0, the wall thickness of the generally tubular polymeric sheath has a normalized dimension of approximately 0.28, and the length of generally tubular polymeric sheath has a normalized dimension of approximately 37.0.

16. The fuse link of claim 15, wherein the inner radius of the generally tubular sheath is approximately 0.154 inch.

17. A method of forming a fuse link, comprising:
providing conductive terminal component having a generally cylindrical insertion region, the generally cylindrical insertion region having a knurled region formed therein;
providing a generally tubular sheath having a first end, a length, an inner radius, and a wall thickness that are together configured such that the generally tubular sheath remains substantially intact when the fusible link experiences a first overload event within a first range of fault current values; and does not remain substantially intact when the fusible link experiences an overload event within a second range of fault current values that is greater than the first range;
inserting the first end of the generally tubular sheath over the generally cylindrical insertion region to form a press-fit connection with the knurled region of the conductive terminal component.

18. The method of claim 17, further including coupling a fusible element to the conductive terminal, wherein the fusible element has a current rating in the range of 1-50 amperes, and wherein the inner radius of the generally tubular polymeric sheath has a normalized dimension of 1.0, the wall thickness of the generally tubular polymeric sheath has a normalized dimension of approximately 0.65, and the length of generally tubular polymeric sheath has a normalized dimension of approximately 54.0.

19. The method of claim 17, further including coupling a fusible element to the conductive terminal, wherein the fusible element has a current rating in the range of 60-100 amperes, further wherein the inner radius of the generally tubular sheath has a normalized dimension of 1.0, the wall thickness of the generally tubular sheath has a normalized dimension of approximately 0.28, and the length of generally tubular sheath has a normalized dimension of approximately 37.0.

20. The method of claim 17, wherein the generally tubular polymeric sheath is comprises an acetal homopolymer material.
